(19) United States
(12) Patent Application Publication
(10) Pub. No.: US 2020/0201332 A1
(43) Pub. Date: Jun. 25, 2020

(54) SURVEILLANCE SYSTEM FOR A WIND PARK, AND ASSOCIATED METHOD

(71) Applicant: Vestas Wind Systems A/S, Aarhus N. (DK)

(72) Inventors: Gunnar K. Storgaard Pedersen, Skjern (DK); Christian Skov Frederiksen, Videbæk (DK); Gerner Larsen, Hinnerup (DK); Ivar J.B.K. Jensen, Hornslet (DK); Klaus Lynge Petersen, Skjern (DK)

(21) Appl. No.: 16/621,048

(22) PCT Filed: Jun. 21, 2018
(86) PCT No.: PCT/DK2018/050154

§ 371 Date: Dec. 10, 2019

(30) Foreign Application Priority Data
Jun. 30, 2017 (DK) PA 2017 70529

(51) Int. Cl. G05D 1/00; F03D 80/00; G08G 5/00; B64C 39/02; B64F 1/36; B64D 47/02; A01M 29/16; A01M 29/18; A01M 29/10; G05D 1/10

(52) U.S. Cl. CPC G05D 1/0094; F03D 80/00; G08G 5/0069; B64C 39/024; B64F 1/362; B64D 47/02; B64C 2201/12; A01M 29/18; A01M 29/10; G05D 1/0088; G05D 1/104; B64C 2201/027; B64C 2201/141; A01M 29/16

(57) ABSTRACT

In a first aspect, the embodiments of the invention provide a surveillance system for a wind park comprising a detection system configured to detect flying birds and issue a detection signal; one or more drones; and a control system configured to command one or more of said drones to be deployed based on the detection of birds flying in the vicinity of the wind park. The invention extends to a wind park comprising a plurality of wind turbines and a system as defined above. The invention also embraces a method of operating a surveillance system in a wind park, comprising scanning a geographical area proximal to a wind park using a surveillance system for the detection of birds; on detecting the presence of birds in the vicinity of the wind park, automatically commanding the deployment of one or more drones to act as a deterrent to the detected birds.

### FIELD OF THE INVENTION

This invention relates to a system and a method for providing surveillance in a wind park for monitoring for the presence of birds and bats. Suitable measures may be taken on detecting birds in the vicinity of the wind park in order to reduce the risk posed to the birds by the rotating blades of the wind turbines in the wind park.

### BACKGROUND OF THE INVENTION

Wind parks tend to be installed in wide-open areas which experience relatively high average wind speeds. Such areas tend to experience high activity from birds and, less commonly, bats. A particular problem is flocks of migrating birds.

Radar systems are known that provide an early warning of high bird activity, which would pick up migrating flocks of birds, for example, and also smaller group of birds. To date, such systems tend to rely on curtailing operation of the wind turbines in the wind park, or shutting down wind turbines altogether in order to lessen the risk posed to birds from the rotating blades of the wind turbines.

It is against this background that the embodiments of the invention have been devised to provide a more effective approach at detecting birds and implementing risk mitigation measures.

### STATEMENT OF INVENTION

In a first aspect, the embodiments of the invention provide a surveillance system for a wind park comprising:
a detection system configured to detect flying birds and issue a detection signal;
one or more drones; and
a control system configured to command one or more of said drones to be deployed based on the detection of birds flying in the vicinity of the wind park.

The invention extends to a wind park comprising a plurality of wind turbines and a system as defined above.

The invention also embraces a method of operating a surveillance system in a wind park, comprising:
scanning a geographical area proximal to a wind park using a surveillance system for the detection of birds;
on detecting the presence of birds in the vicinity of the wind park, automatically commanding the deployment of one or more drones to act as a deterrent to the detected birds.

The detection system may comprise an avian radar system. The detection system may be configured to issue a detection signal or trigger a detection event, as soon as birds have been detected or, in another embodiment, it may trigger a detection event when it detects birds within a predetermined range of the detection system. The event signal may provide information to the control system about the number of birds that have been detected, and ma also provide further information about the size of the flock, range data, and geographical spread of the flock. It may even be able to make a prediction about the type of bird, which may influence the type of deterrent approach that is used.

Where information/data is available about the number of birds that have been detected, the control system may be configured to command deployment of a selected drone group, the size that group being dependent on the number of birds that have been detected.

At least one of the drones may be equipped with an audio emitter for emitting audible deterrents to birds. This may be an ultrasonic emitter for example but may also be configured to emit sounds in the audible range for humans for example predator sounds or distressed bird calls. In other embodiments, at least one of the drones is equipped with visual emitter for emitting visual deterrents to birds. This might include white or coloured lights, steady or flashing, and optionally arranged in a pattern.

The one or more drones may be equipped with an automatic flight control system to enable autonomous flight. The control system may direct the one or more drones to fly towards the detected birds.

The one or more drones may be launched from an operations base which provides the drones with environmental protection when not in flight. The operations base can also provide a charging system for charging the one or more drones.

### BRIEF DESCRIPTION OF THE DRAWINGS

The invention will now be described by way of example with reference to the accompanying drawings, in which:

FIG. 1 is a schematic diagram of an exemplary unmanned air vehicle system for use in the embodiments of the invention;

FIG. 2 is a schematic diagram of a surveillance system for use with the unmanned air vehicle or ‘drone’ system of FIG. 1;

FIG. 3 is a diagram that illustrates an example of a surveillance system for a wind park;

FIG. 4 is a flowchart illustrating a principle of operation of the surveillance system;

FIG. 5 is a pictorial representation of a principle of operation of the surveillance system.

FIG. 6 illustrates a response action to the detection of birds by the surveillance system;

FIG. 7 illustrates a further response action to the detection of birds by the surveillance system; and

FIGS. 8 to 10 illustrate further response actions to the detection of birds by the surveillance system.

### DETAILED DESCRIPTION OF EMBODIMENTS

Embodiments of the invention provide unmanned aircraft systems (UAS) and unmanned air vehicles (UAV), in order to provide an effective approach to detect and protect flying flocks of birds from interacting with wind parks. For brevity, this discussion will refer to a ‘drone’ as any type of unmanned air vehicle.

In general the embodiments of the invention provide a novel approach for mitigating the risk that wind parks are considered by some environmental activist groups to pose to avian wildlife, particularly migrating flocks of birds. In a broad sense, the embodiments relate to a surveillance system that is configured to detect flying wildlife using suitable means of detection and to generate a deterrent response to stop the detected wildlife coming near to the wind park. Principally it is considered that a Radar system is currently a viable means of detecting flying birds, although other systems would be possible. Once a bird detection event has occurred, the surveillance system is able to make a judgment on the appropriate response action required by the event. The response action may be influenced by several factors which will be discussed in detail later. Notably, however, the surveillance system may trigger the deployment of one or more drones in order to halt continued advancement of birds towards the wind park. For flocks of birds, a plurality of drones in the form of a swarm may be deployed which may take an appropriate action to ward off the birds and divert their flight path.

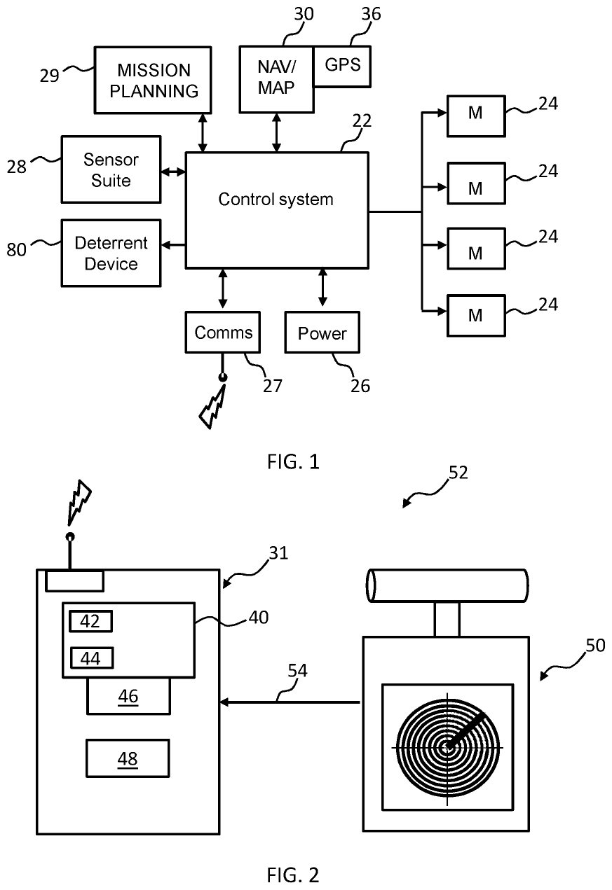

To put the invention into context, FIG. 1 illustrates a system diagram of a typical systems architectural platform of a drone 20 which may be used in the implementation of the embodiments of the invention. In overview, the drone 20 or ‘drone system’ includes: a control system 22, one or more propulsion units 24, a power system 26, a communication system 27, a sensor suite 28, mission planning system 29 and a navigation system 30. The drone 20 may be operated in conjunction with a ground- or base-station computer system 31, hereinafter referred to as the ‘ground-station’, which will be described in more detail later with reference to FIG. 2. The various electronic components may be linked by suitable data and power connections, which are either direct connections or by way of a networked data and power bus, such as a CAN-bus (Controller Area Network), which is a common interconnection architecture as would be understood by the skilled person.

The control system 22 is the main computing unit that controls the flight of the drone 20 by controlling the propulsion units 24 based on inputs from the sensor suite 28 and navigation system 30. The control system 22 may implement remote control flight based on received control inputs from a ground based controller, autonomous flight, based on its internal mission planning algorithms, or semi-autonomous flight, in which a blend of on-board mission planning and ground based direction are used. The main responsibility of the control system 22 is as a lower layer controller which is responsible for positional control of the drone (altitude and lateral position), attitude control (pitch, roll and yaw), and velocity control (horizontal and vertical speed) based on remote control actions or based on self-generated flight directions. The control system 22 comprises a suitable processing environment having a processor 32 and a memory 34 with associated on-board communications functionality, such as a data bus, so it is able to communicate with the other on-board systems.

To directly control the flight profile the control system 22 communicates with the one or more propulsion units 24. Four propulsion units 24 are shown here, as would be consistent with the drone system 20 being a quadcopter. However, more or fewer propulsion units are also appropriate. For example an autonomous helicopter may have a single propulsion unit, and, in general, remote control and autonomous multirotor system are known with more or fewer than four rotors. Sometimes these are referred to collectively as aerial robotic systems. The propulsion units may be any suitable units for providing controllable flight for the drone, and may be electric motors driving suitable rotor blades, as are typical with so-called quadcopters (more generally referred to as multirotors) of varying size and lift capacities. However, the propulsion units 24 may also be gas turbines or internal combustion engines, for example.

The on-board power system 26 is selected to be suitable for the propulsion units 24. For example, for electric motors the on-board power system 26 may be a battery pack, a fuel cell, or even an external power plug so as to receive electrical power from an external source. Conversely, the power system 26 could be an on-board fuel tank in the event that the propulsion units are gas-turbines or ICEs.

The communication system 27 provides the means to send and receive data to and from systems that are external to the drone 20. For example, the drone 20 may send telemetry data to the ground station 31, and may send positional, attitude and velocity data to other drones operating in the area, either as part of a drone swarm or operated independently. The communication system 27 may also receive data from external systems, and in this context it may receive remote control commands from the ground station 31 if the drone 20 is operated in remote control flight mode. Such control may take the form of flight path information or waypoints for the drones to follow, rather than direct control commands relating to the propulsion units 24. Alternatively it may upload mission data from the ground station. The communication system 27 also permits incoming and outgoing (two-way) communication with other drones so that flight paths and mission objectives can be coordinated with them to achieve a collective goal. The communication system 27 may direct signals by any means known in the art including, but not limited to, cellular or other phone-based networks, over remote control radio frequency links, UHF or L-band frequency links, microwave frequency links, or other appropriate datalinks, networks, or communication paths.

The sensor suite 28 is operably connected to the control system 22 and provides appropriate sensor data to assist with the operation of the drone. For example, the sensor suite may comprise proximity detectors, a global navigation satellite system/global positioning system (GNSS/GPS) unit for positioning control, optical still and video cameras for carrying out inspection and guidance tasks, inertial navigation units, to name a few examples. Typically such a sensor suite 28 would be adaptable to carry more or fewer sensors as required for a particular task. Note that in this context the GPS unit may receive signals directly from satellites in order to fix the position of the drone, although another option would be to implement a differential GPS system (known in the art) which receives signals from a ground-based differential GPS beacon in order to provide a higher positional accuracy compared to direct GPS. Note that a GPS unit 36 is shown here as being integral with the navigation system 30.

Mission planning system 29 provides a link to the ground station 31 to store missions that have been generated thereon and to which the drone follows in use. The mission planning system 29 may include suitable memory storage and algorithms to store, provide and generate on the fly appropriate mission objectives, waypoints, operational envelopes and so on.

Navigation system 30 provides control inputs to the flight control system 22 regarding path following based on input from GPS data and/or from the sensor suite 28. In embodiments where the drone flight is automated, the navigation system 30 may execute a predetermined mission along a predetermined flight path, either generated for it by the ground station 31, or generated by the drone on-the-fly. Alternatively, the navigation system 30 may be controlled remotely and may require user input such as steering commands.

Having described the functional components of the drone 20, discussion will now turn to the ground station 31 as shown in FIG. 2. Ground station 31 provides a ground-based control hub for the one or more drones 20 and is suitably equipped with a computing platform 40 being a controller having an appropriate processing module 42 and memory storage 44. The computing platform 40 implements a suitable ground station software package 46 to provide appropriate ground station facilities for controlling and coordinating the one or more drones. For example, the software package 46 may include telemetry feeds, status information updates, first person visual (FPV) feeds, mission planning interfaces and algorithms and so on. A user interface 48 is provided to enable to a user/operator to view data relating to the drone system and to input control and parameter data into the ground station. The user interface 48 may comprise a display screen and audio output, and a user input means such as a keyboard, joystick, mouse, on-screen buttons or a combination of these. The ground station also has a communications system 50 in order to send data to and receive data from the one or more drones.

In the context of the invention, the ground station 31 is responsible for configuring the parameters which will trigger a bird detection event and the response actions that should be implemented following a bird detection event. Appropriate software is provided for this use for an operator to set up these parameters and configurations.

In order to provide the functionality for detecting birds at a distance from the wind park, the ground station is connected to a detection system in the form of a Radar system 50. Together, the ground station 31 and the Radar system 50 form a surveillance system 52 that is operable to monitor for the presence of birds within the vicinity of the wind park, or that are determined may be on a flight path which may intercept or interact with the wind park, and to take a suitable response action.

The Radar system 50 comprises any suitable radar equipment that is capable of identifying one or more birds approaching or in the vicinity of the wind park. It is envisaged that the radar system 50 may include a pulse-doppler radar system operating in the L-band or X-band frequencies. Several such avian radar systems are commercially available for example from Robin Radar Systems B.V, the SharpEye™ avian radar system from Kelvin Hughes Limited, and the Merlin™ avian radar system available from De-Tect, Inc. The radar system 50 is operable to provide an indication that birds have been detected. In this embodiment, the indication is provided by the radar system 50 generating a bird detection event signal 54. It should be noted, however, that other means of indication may be possible. In addition to indicating that one or more birds have been detected at a certain geographical location, the signal may include other useful information such as the number of birds detected, the geographical spread of the bird flock, the number of individual flocks detected, tracking information on the detected bird flocks, and predicted flight path information of the flock or flocks of birds. It will be appreciated that reference here to ‘birds’ includes reference to other avian creatures such as bats.

As shown in FIG. 2, the ground station 31 and the radar system 50 are separate units. This may be an appropriate way to configure the surveillance system 52, but it is also envisaged that the ground station 31 and the radar system 50 may be integrated into a single unit.

It should be appreciated that the above description of a drone system 20 is intended as merely an example of the main components of an autonomous air vehicle and that other components may also be included in a typical system. In general, it should be noted that drones for use in the embodiments of the invention are known and are able to perform in remote control flight modes, semi- and fully-autonomous flight modes, and are able to carry out manoeuvres in a coordinated fashion in fixed formations with other drones.

A suitable drone for this application is the Matrice series from DJI, for example the M200 or M600. Other, preferably commercial grade, drones would also be suitable. Important characteristics to consider are flight endurance, robustness, suitability for swarm, autonomous control and ability to interface with a ground station for mission planning, control, telemetry data and so on

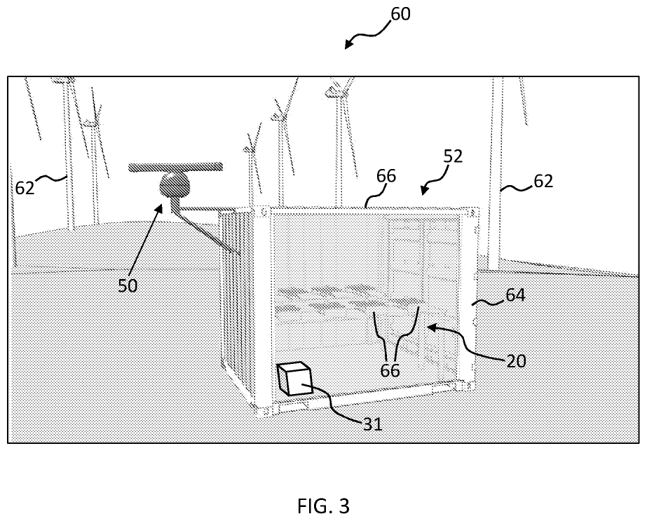

The above discussion focuses on an example of a surveillance system including a suitable drone architecture which may be used to give the invention context. The discussion will now focus on particular functionality of the surveillance system with reference to FIGS. 3 to 10

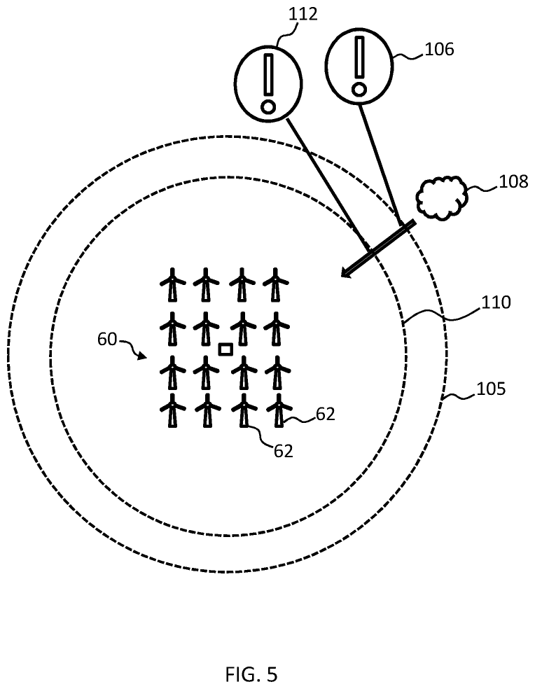

Referring firstly to FIG. 3, the surveillance system 52 is shown located in a wind park 60, surrounded by an array of wind turbines 62. In principle, the surveillance system 52 may be located anywhere in the wind park 60, and even outside of it, as long as the effective detection range of the surveillance system 52 is sufficient to provide appropriate geographical coverage of the wind park 60 so that birds can be detected before they interact with the wind park by flying to close to or through it. An approximate central location within the wind park 60 has the advantage that it provides the surveillance system 52 with an effective range that extends about the wind park in a consistent way. This can be seen in FIG. 5 in which the circular area of geographical coverage of the radar system is centred on the surveillance system 52 sited roughly in the middle of the wind park.

As mentioned above, the surveillance system 52 shown in FIG. 3 comprises the ground station 31, the radar system 50 and a fleet of drones 20. An operations base 64, in the form of a cabin, provides a location to store the drones 20 and the components of the surveillance system 52. The operations base 64 may be equipped with appropriate charging points 66 (two of which are shown here) with which the drones 20 are able to dock with autonomously when re-charging is required. Here, the operations base 64 is shown as a shipping container, but this is just an example. Any appropriately-sized structure would be suitable. The operations base 64 may be permanently open so as to provide an open area for drones to fly out of and back into it, which therefore acts as a docking bay for the drones. In this embodiment, however, the operation base 64 has an openable roof 66 to provide better environmental protection to the components within it. An openable roof is beneficial since the drones may fly vertically upwards during deployment and descend vertically downwards when recalled to base. However, openable doors may be provided on the sides of the operations base instead of, or in addition to, the openable roof 66. Note that the side wall of the operations base 64 is shown as translucent so that the internal components can be seen.

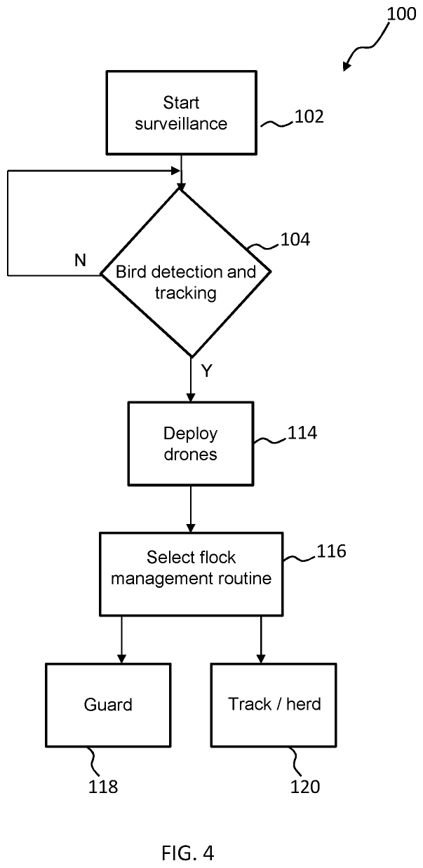

Although not shown here, it should be appreciated that the surveillance system 52 may comprise a plurality of radar systems 50 located around the wind park 60 to ensure good coverage, as the wind turbines 62 and other structures within the wind park 60 may cause shadowing on a centrally located radar system 52. Reference will now also be made to FIG. 4, which is a flowchart that illustrates a general overview of the operational process 100 of the surveillance system 52.

Initially, surveillance is started at step 102. It is envisaged that the surveillance system 52 may be powered up upon commissioning of the wind park and will be operational whenever the wind park is operating to provide protection to birds. However, optionally the surveillance system 52 could instead be configured only to be operated during high risk periods, for example during times when bird migration is to be expected.

The process then moves onto a monitoring routine 104 where the radar system 50 scans for birds within a boundary representing its effective operational range. This is shown as the outer circle labelled as ‘105’ in FIG. 5. The effective operational range 105 may be dependent on the capabilities of the radar system 50 that is selected for the purpose. In other embodiments, the system may be configured to have a predetermined range in selected angular directions. For example, the profile of the range boundary 105 need not be circular, as in the illustrated embodiment, but instead may be irregular such that it is configured to extend further in one direction compared to others. This may be useful where the majority of bird migration can be expected to come from a certain direction.

The radar system 50 continues its monitoring routine 104 and will issue a bird detection event signal 54 in circumstances where birds are detected. Before moving on to subsequent steps in the process, the bird detection event signal will be discussed in more detail.

The radar system 50 may be configured to generate bird detection event signal 54 when it detects one or more birds. The number of birds that are required to trigger an event signal may be influenced by the sensitivity of the system. For example, the system may only be sensitive enough to detect groups of ten or more birds, so that ten birds is the minimum number of birds in a group that will trigger the generation of a signal. The radar system 50 may also be sensitive enough to detect individual birds. In such circumstances, it may be considered useful to configure the radar system 50 only to generate a bird detection event signal 54 when a predetermined number of birds have been detected. This approach attempts to balance the small risk presented to individual birds against the too frequent deployment of the drone fleet.

As shown in FIG. 5, a bird detection event signal may be generated as soon as the radar system 50 has detected birds, for example a flock of birds 108, that have encroached within the outer limits of the effective operational range 105 of the surveillance system 52. This is indicated by the first alert symbol 106 in FIG. 5. This provides early warning of an approaching flock of birds 108 and, indeed, may be necessary if the maximum range of the radar system 50 is relatively limited.

An alternative approach is to identify the flock of birds 108 once it has travelled past the outer range limit, and then to track the progress of that flock based on the data generated by the radar system 50. If the flock continues on its flight heading towards the wind park 60 past a predetermined boundary 110 then this will trigger the radar system 50 to generate a bird detection event signal. This is indicated by the second alert symbol 112 in FIG. 5. Usefully, this approach may result in a reduction in the number of drone deployments as an event signal will only be triggered once the flock of birds passes a predetermined proximity boundary that has been configured for that purpose. Therefore, if the flock of birds diverts its flight path after initially being detected, and without passing the inner boundary 110, it will not be a risk and a bird detection event signal will not be generated.

The bird detection event signal 54 may simply be a notification signal that a bird flock has been detected and, in response, the ground station will carry out a response action based on drone deployment. However, the bird detection event signal generated by the radar system 50 may be configured to contain useful data which the ground system can use to provide a more sophisticated response action. For example, the bird detection event signal may include useful information content such as the number of birds detected, the geographical spread of the bird flock, the number of separate flocks detected, tracking information on the detected bird flocks, including velocity, altitude and heading, and predicted flight path information of the flock or flocks of birds.

Such technical content of the event signal will largely depend on the capabilities of the radar system 50.

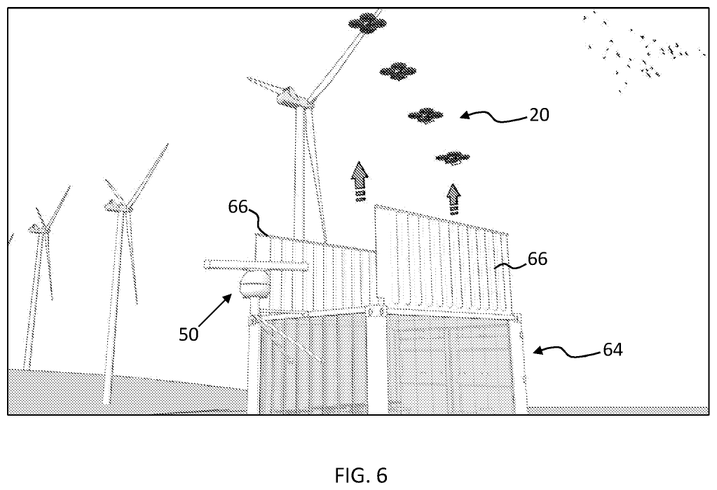

Once birds have been detected, the surveillance system 52, more specifically the ground station 31 in this embodiment, will make a decision to launch or deploy drones (step 114) based on that signal. Drone deployment is illustrated in FIG. 6 in which a group of drones 20 is flying vertically upwards from the operations base 64, through a set of opened double doors 66. It will be appreciated that this upper door configuration allows rapid deployment of the drones since they are well suited to this flying manoeuvre.

The surveillance system 52 may take a number of different approaches to deploying the drones. For example, the all drones may be deployed as a standard or default position, or it may base a decision to deploy a selected number of the drone fleet based on the information contained in the bird detection event signal. For example, the precise number of drones deployed may be based on the estimated number of birds in the flock that has been detected. Once the drones have been deployed by the surveillance system 52, they may act in coordination with one another to discourage the flock of birds from approaching closer to the wind park. To do this the drones may operate autonomously based on pre-determined mission profiles uploaded to them by the ground station 31. For example, that mission profile may instruct the drones to fly to a predetermined geographical location and altitude which intercepts the flight path of the detected flock of birds. In this way, the drones may act passively and simply follow the commands of the surveillance system 52. This is indicated in FIG. 4 by the steps of ‘selecting flock management routine 116 which leads to two exemplary options of ‘guard’ 118 and ‘herd’ 120. Whereas in the guard routine 118 the drones may maintain fixed position and altitude coordinates with respect to the wind park, in herd mode 120, the drones may be commanded to move together in a pre-determined flight formation towards the flock of birds, which is being tracked by the surveillance system, in an attempt to drive that flock away from the wind park.

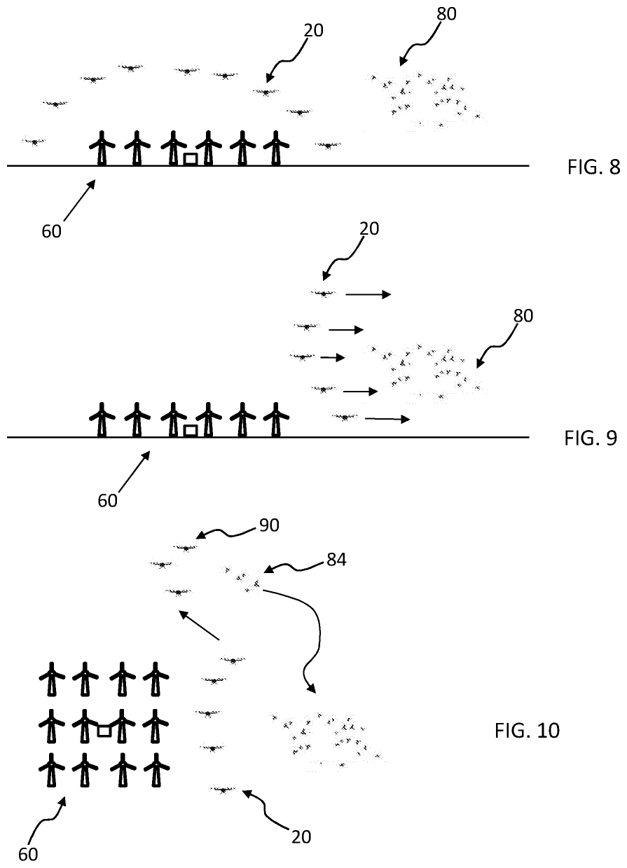

FIGS. 8 and 9 show examples of this. In FIG. 8, the wind park 60 is shown with a swarm of drones 20 stationed over it in a geometrical formation. Here, that formation is like a dome such that the birds will be deterred from flying anywhere near the wind park 60 as it is shielded by a cap of drones. Other geometrical configurations are possible—for example, the drones could adopt a formation which resembles a planar vertical wall having a predetermined shape, for example oval or rectangular, designed to shield the wind park 60 from the approaching birds. The drones could also be configured to fly in such a formation, but having a domed or dished profile, either being convex or concave with respect to the wind park. FIG. 9 illustrates an example of this where a wall of drones 20 has adopted a concave formation such that it is deeper in the middle of the drone formation proximal to the flock of birds. The outer edges of the drone formation therefore extend further towards the flock of birds which deters the birds from flying up and over the drone formation. In FIG. 9, the drones are illustrated as advancing on the flock 80 with a view to driving the birds away from the wind park 60.

It is envisaged in one embodiment that the drones may be responsive to the movement of the flock of birds which would improve the herding capability of the drone fleet. To this end, the surveillance system 52 may transmit data to the drone fleet regarding the geographical position and altitude of the flock of birds, and about the size of the flock. The drone fleet would then be able to adapt their flight formation to match the size of the flock to reduce the likelihood that the flock will split.

If the flock of birds does split such that groups of birds fly in different directions, they the surveillance system 52 is configured to detect this via the tracking information provided by the radar system 50, and divert a selected number of the drones in a “pursue and retrieve” mission. This is illustrated in FIG. 10, in which a drone group 90 is partitioned off from the main group of drones 20 in order to pursue a group of birds 82 that has split off from the main flock 80. In the illustrated embodiment, the bird grouping 84 may be returned to the main flock 80, but this is not essential and, instead, the drone group 90 could be configured to herd or shepherd the bird grouping 84 in a different direction away from the wind park 60.

Although the drones in themselves provide a suitable deterrent to urge the flock of birds away from the wind park, the effect of the drones may be enhanced by equipping some or all of the drones with suitable bird deterrent devices 80 (see FIG. 1).

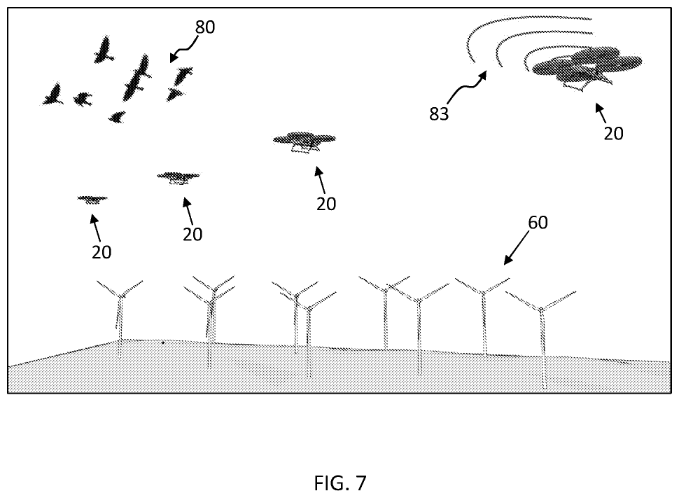

One type of deterrent device 80 is an audio or sonic deterrent device. Such devices are commercially available and could be installed on a suitable drone platform. A sonic bird deterrent device is configured to emit sound that repels birds, and this might be in the form of a predator sound, a species-specific distress call, or an ultrasonic sound. This is illustrated pictorially in FIG. 7, where a group of drones 20 are advancing in a line towards a flock of birds 80 whilst emitting an audio signal 83 in order to drive the birds away from a wind park 60.

An ultrasonic device would have the benefit that the sounds would not be audible by human ears, which would be an advantage if the surveillance system 52 is located in proximity of a residential area.

The deterrent device 80 may also include a visual deterrent. For example, the drone may be equipped with a visual emitter. This may take the form of one or more high-powered LED devices that are configured to flash at a predetermined frequency.

Various embodiments of the invention have been described above. However, the skilled person would appreciate that the illustrated embodiments could be varied or adapted in ways that would not depart from the inventive concept, as defined by the claims.

1. A surveillance system for a wind park comprising:
a detection system configured to detect flying birds and issue a detection signal;
one or more drones;
a control system configured to command one or more of said drones to be deployed based on the detection of birds flying in the vicinity of the wind park.

2. The system of claim 1, wherein the detection system comprises an avian radar system.

3. The system of claim 1, wherein the detection system issues a detection signal in response to the detection of birds.

4. The system of claim 1, wherein the detection system issues a detection signal when it detects birds within a predetermined range of the detection system.

5. The system of claim 1, wherein the detection signal provides information to the control system about the number of birds that have been detected.

6. The system of claim 4, wherein the control system is configured to command deployment of a selected drone group on receiving a detection signal, the size of the drone group being dependent on the number of birds that have been detected.

7. The system of claim 1, wherein at least one of the drones is equipped with an audio emitter for emitting audible deterrents to birds.

8. The system of claim 7, wherein the audio emitter is an ultrasonic emitter.

9. The system of claim 1, wherein at least one of the drones is equipped with visual emitter for emitting visual deterrents to birds.

10. The system of claim 1, wherein the one or more drones are equipped with an automatic flight control system to enable autonomous flight.

11. The system of claim 1, wherein the control system directs the one or more drones to fly towards the detected birds.

12. The system of claim 1, wherein the one or more drones are launched from an operations base which provides the drones with environmental protection when not in flight.

13. The system of claim 12, wherein the operations base includes a charging system for charging the one or more drones.

14. The system of claim 12, wherein the operations base includes a door that is operable by the control system.

15. A wind park comprising a plurality of wind turbines and a system as claimed in claim 1.

16. A method of operating a surveillance system in a wind park, comprising:
scanning a geographical area proximal to a wind park using a surveillance system for the detection of birds;
on detecting the presence of birds in the vicinity of the wind park, automatically commanding the deployment of one or more drones to act as a deterrent to the detected birds.

17. The method of claim 16, wherein deployment of one or drones occurs as soon as birds have been detected by the surveillance system.

18. The method of claim 17, wherein deployment of the drones occurs once the detected birds have come within a predetermined distance of the wind park.

19. The method of claim 16, including gathering information about the number of birds detected using the surveillance system.

20. The method of claim 19, including deploying a predetermined number of drones in dependence on the number of drones that have been detected.

21. The method of claim 16, including tracking the flight path of the birds that have been detected.

22. The method of claim 16, including guiding the one or more drones toward the area in which the birds have been detected.
